(19) United States
(12) Patent Application Publication
(10) Pub. No.: US 2011/0166880 A1
(43) Pub. Date: Jul. 7, 2011

(54) Method and System for Analyzing Health Related Data of Patients

(75) Inventors: Amnon Keynan, Tel Aviv (IL); Amir Weinstein, Petach Tikva (IL); Arturo Weschler, Kfar Saba (IL)

(73) Assignee: HEALARIUM INC., Wilmington, DE (US)

(21) Appl. No.: 13/062,730

(22) PCT Filed: Sep. 3, 2009
(86) PCT No.: PCT/IL09/00857

§ 371 Date: Mar. 8, 2011

Related U.S. Application Data
(60) Provisional application No. 61/094,986, filed on Sep. 8, 2008.
(60) Provisional application No. 61/138,177, filed on Dec. 17, 2008.

(51) Int. Cl. G06Q 50/00; G06Q 10/00

(52) U.S. Cl. 705/2

(57) ABSTRACT

System and method for analyzing health related data associated with a patient, comprising: an expert's station; a health database comprising health related data of patients; a wizard application, enabling the expert to create a template of commands for analyzing the health related data of the patient according to the expert's school of method, using a generic model associated with the expert's field of expertise, where the analysis calculates health related profile of the patient; a templates database comprising templates of commands created by experts; a generic models database, enabling the wizard to retrieve and store a generic model associated with the expert's field of expertise; and a main server for using the template of commands to analyze the health data of a patient, according to the analysis method of the expert, by operating the commands in the template for calculating health related profile of the patient.

### CROSS REFERENCE TO RELATED APPLICATION

This application claims the benefit of U.S. Provisional Patent Application 61/094,986, filed Sep. 8, 2008 and of U.S. Provisional Patent Application 61/138,177, filed Dec. 17, 2008, which are incorporated herein by reference in their entirety.

### FIELD OF THE INVENTION

The present invention relates generally to the field of systems and methods for analyzing, presenting and processing of data and more particularly, to systems and methods for analyzing, processing and presenting of health related data.

### BACKGROUND OF THE INVENTION

Health related data includes a variety of data types. Health related data may include a patient's personal details such as the patient's age, sex, height, weight and the like and can also be values of measurable parameters such as blood pressure, pulse, blood test results and the like, or parameters that are deduced from other measurable parameters such as Body Mass Index (BMI), which is the weight of the patient (e.g. in Kg) divided by the squared value of the patient's height (e.g. in meters): [Kg]/[M ̂2].

To diagnose a patient and/or to identify the patient's health state, and provide the patient with a health care plan that is in correlation with the patient's health data, each professional expert has to view all related health data such as test results and the patient's personal details and decide upon the treatment according to the data as well as according to one or more school method the expert believes in or learned. For example, one of the experts may be a Dietitian that follows a first school of dieting and exercising method that asserts that a BMI of a female under the age of sixty should exceed the value of 20 before considering the patient to be over weighted, where a second dietitian only considers the value of BMI 20 as an over weight if the patient is under the age of twenty. Each of them may also have very different dieting and exercising programs. This means that the same patient having the same health data at a certain period of time in his/her life may receive different analysis results asserting a different health state relating to the same field of health and expertise of the experts.

It is obvious that some methods and systems for interpreting health related data and for treatment are proven better than others over time and study and that some experts have better success than others. Additionally, new and novel studies may change the knowledge and method of interpreting data and treatment for many experts in many realms of health related expertise.

Today, health data of patients is easy to store, retrieve and process, using computerized systems. Most Clinics and Health Organizations (HO) keep records of health related data and personal data of all their registered patients. Additionally, most clinics and HOs enable storing and presenting most if not all test results carried out in the organization for the expert physician or therapist to view and decide upon the patient's health condition. For example, physicians can view some if not all test results (e.g. blood/urine tests, X-ray results, personal details and many others) and the values of some measurable parameters (e.g. blood/urine tests results, pulse and blood pressure measures and the like) and decide whether the patient's measured values exceed a normal range or are considered dangerous to the patient according to standard normal ranges and also according to the patient's personal details and medical history.

Clinics and HOs do not provide tools that allow each expert to view a patient's health data in an organized manner that suits his/her school of method. There is also no tool provided for the experts allowing each expert to create his/her own personal tool using easily customizable generic tool or module, enabling to process the health data of a patient according to the expert's school of method to allow each expert to view indicators indicating the patient's health condition and profile according to the expert's definitions and conditions.

### SUMMARY OF THE INVENTION

The present invention, in some non-limiting embodiments thereof, provides a system and a method, enabling experts in various health related fields such as physicians, therapist, psychologists, dietitians, sports trainers and the like, to create their own personal analysis tools using a generic model that can easily be customized by the expert to allow using health data of patients, process this data according to conditions and commands defined by the expert and output a graphical representation of the patient's health factor and parameters according to the processing and presentation definitions customized by the expert.

The results of the processed health data may represent various aspects and presentations of the patient's health state(s) according to the expert's customized analysis. The resulting states may be presented to any authorized user such as at least one of: the patient, the expert and/or other experts.

According to one aspect of the invention, there is provided a system for enabling to analyze health related data associated with at least one patient. The system may comprise: (1) at least one expert's station, which is a computerized station of a health related expert; (2) at least one health database comprising health related data of patients; (3) a wizard software application operatively associated with the at least one expert's station, enabling the expert to create at least one template of commands for analyzing the health related data of the patient according to the expert's analysis school of method, using at least one generic model associated with the field of expertise of the expert, wherein the analysis calculates health related profile factors and condition of the patient; (4) at least one templates database, enabling to store templates of commands created by the expert; (5) at least one generic models database, enabling the wizard to retrieve and store a generic model associated with the expert's field of expertise; and (6) at least one main server, operatively associated with the wizard, the expert's station, the health database and the templates database, enabling to retrieve data from and store data in the databases and use the template of commands to analyze the health data of a patient, according to the analysis method of the expert. The analysis may be carried out by operating of the commands in the template, wherein at least one of the commands in the template enables calculating of at least one health related profile factor of the patient.

According to another aspect of the invention, there is provided a computer implemented method of enabling to analyze health related data associated with at least one patient. The method may comprise: (1) retrieving a generic model that is associated with the expert's field of expertise; (2) enabling the expert to create a template of commands, using the retrieved generic model, wherein said template allows analyzing health data of the patient according to the expert's analysis school of method; (3) receiving health related data of a patient; and (4) analyzing the received health related data according to the expert's template of commands by operating the commands of the template using health related data of said patient. The commands may enable calculating at least one health related profile factor of the patient.

According to yet another aspect of the invention, there is provided a computer implemented method of providing at least one suitable health related care plan of an expert to patients' health related goals. The method may comprise: (1) assigning suitability of the expert's care plan to possible patient's health related goals by customizing rules of at least one generic model enabling said assignment; (2) creating a suitability assignment template of the care plan, which includes all the customized rules of the generic model; (3) receiving at least one health related goal of a patient; (4) determining the suitability of known care plans in relation to the received goal, according to the suitability assignment template of each of the care plans, wherein the suitability is calculated according to the customized rules of the suitability assignment template in of each care plan in relation to the received goal; and (5) presenting care plans that are most suitable in relation to the received health related goal.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram, schematically illustrating a system for analyzing and presenting health related data, according to some embodiments of the invention;

FIG. 2 is a block diagram, schematically illustrating a main server of the system for analyzing and presenting health related data, according to some embodiments of the invention;

FIG. 3 is a block diagram, schematically illustrating a wizard for allowing a health related expert to customize and create templates for analyzing and presenting health related data, according to some embodiments of the invention;

FIG. 4 is a block diagram, schematically illustrating a generic model interface of a system for customizing of an analysis tool for health related data, according to some embodiments of the invention;

FIG. 5 is a block diagram, schematically illustrating an output presentation sheet presenting calculated health related profile factors of a patient, according to some embodiments of the invention;

FIG. 6 is a flowchart, schematically illustrating a method for customizing of an analysis tool for health related data, according to some embodiments of the invention;

FIG. 7 is a flowchart, schematically illustrating the process of customizing of an analysis tool for health related data, according to some embodiments of the invention;

FIG. 8A is a block diagram, care plans customization module for assigning suitability factors to experts care related plans and allowing experts to prepare and customize care plans, according to some embodiments of the invention;

FIG. 8B is a block diagram, schematically illustrating a plans retrieval application for enabling a user to retrieve health related plans according to the plans suitability, according to some embodiments of the invention;

FIG. 9 schematically illustrates a plans management application for managing presentation of care plans to patients, according to some embodiments of the invention;

FIG. 10 is a block diagram, schematically illustrating a plans-goals suitability customization tool, enabling an expert to define health related care plans and customize the rules and definitions associating the defined plans with possible patients' health related goals, according to some embodiments of the invention;

FIG. 11 is a flowchart, schematically illustrating a method for customizing a generic model for determining the suitability of a care plan to at least one patient's health related goal, according to some embodiments of the invention; and

FIG. 12 is a flowchart, schematically illustrating the process of retrieving and presenting suitable care plans to a patient according to the patient's related properties and goal, according to some embodiments of the invention.

### DETAILED DESCRIPTIONS OF SOME EMBODIMENTS OF THE INVENTION

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, according to some non-limiting embodiments thereof, provides a system 100 and a method that enable at least one health expert 10 of one or more health related fields of expertise to create a personal analysis tool referred to herein as a “template of commands” that can (i) process and analyze health related data of patients 20 according to the expert's 10 school of method (analysis method); and (ii) present the analysis results (either to himself and/or to the patient 20) according to presentation and interface features that can be customized and/or defined by the expert 10.

The expert 10 in this document refers to any expert in one or more health related fields such as a physician, therapist, a psychologist, a dietitian, a sports trainer and the like.

The patient 20 may be any human or animal subject for whom the expert 10 carries out the profile analysis.

“health related data” and/or “health data” referred to in this document, relate to various data types relating to the patient 20, such as:

the patient's 20 personal details such as name, age, gender, address, phone number etc.;

measured parameters values associated with the patient 20 such as the value (in predefined units) of the patient's weight, height, blood pressure, pulse, blood/urine tests results, and the like;

deduced parameters values associated to the patient 20 such as BMI, relative values and the like; and/or

any other content (e.g. free text) describing the medical diagnosis or analysis of the patient relating to specific medical tests or examination.

The parameters and deduced parameters may be indexes and deduced indexes, respectively, indicating the patient's 20 input and deduced measures (e.g. blood pressure, pulse, weight, height BMI etc.) and personal details (age, name, ID number, etc.).

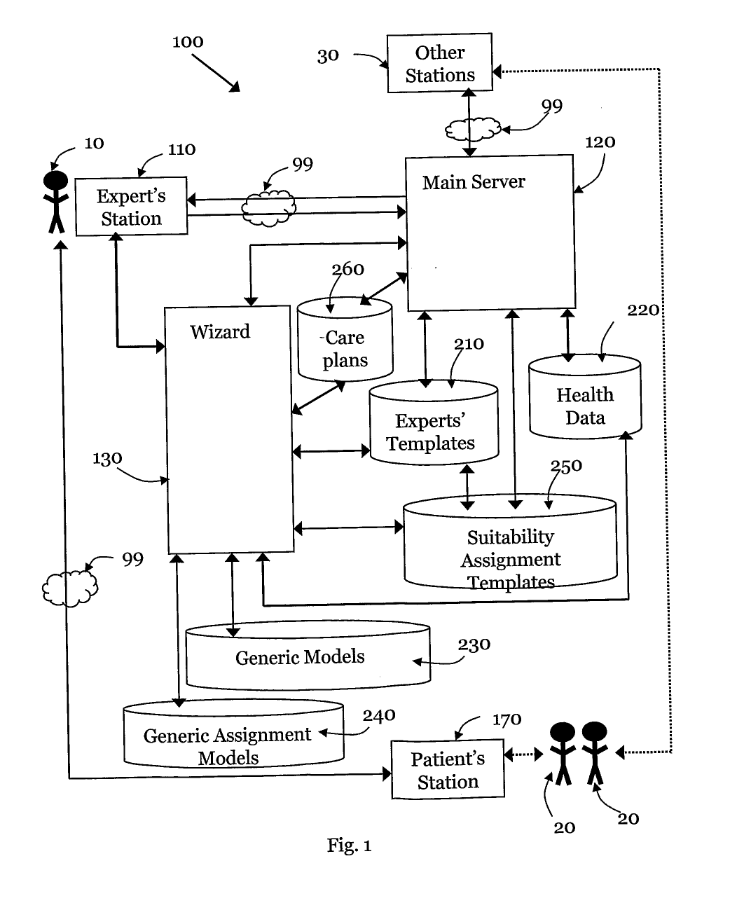

FIG. 1 is a block diagram, schematically illustrating a system 100 for customizing health related analysis tools, according to some embodiments of the invention.

According to these embodiments, the system 100 may comprise:

at least one expert's station 110, associated with at least one expert 10;

at least one main server 120;

a wizard 130 application;

at least one patient's station 170;

other stations 30;

at least one experts' templates database 210;

at least one health database 220; and

at least one generic models database 230.

The expert's station 110 may be any computerized unit that the expert 10 can use to view health related data, transit data, process health related data and/or input health related data of patients 20 such as, for example, a PC, a laptop computer, a mobile phone, a PDA device, etc.

The main server 120 may be any computerized unit enabling to process, transmit and retrieve data and communicate with a multiplicity of experts', patients' and other stations 110, 170 and/or 30 and other computerized terminals, as known in the art.

The patient's station 170 may be any computerized unit that the patient 20 can use to view and process health related data according to one or more Expert's 10 method, the Patient's station 170 may be, for example, a PC, a laptop computer, a mobile phone, a PDA device, etc.

The other station(s) 30 may be any other computerized unit(s) enabling other external personals such as other experts 10 or therapists (e.g. nurses and lab technicians who take measurements of the patient's 20 body measures such as pulse, blood pressure, blood counts etc.) to input patient's health data to be stored, for example, at the health database 220.

The health database 220 may be an external data base and/or an internal database that is stored in the main server 120.

The communication between at least two of the experts' stations 110, the server 120, other stations 30, and the patient's stations 170; may be carried out over any one or more communication networks 99 known in the art such as the internet, intranet, wireless communication networks and the like.

According to some embodiments of the invention, wizard 130 may enable the expert 10 to use a generic model associated with the expert's 10 field of health related expertise (e.g. a generic model for the field of diets, a generic. model for the field of sports etc.) to build a template of commands according to which patients 20 health related data is to be analyzed and processed to calculate profile factors and analyze the patient's 20 health related condition according to those factors.

The main server 120 may enable retrieving the template of commands created by the expert 10 and calculate those factors and carry out the analysis of a patient 20 health condition by operating the commands of the template (retrieving the template from the experts' templates database 210. The factors and overall analysis of the patient's health condition may be presented to the expert 10 and/or the patient 20, where the presentation may also be customized by the expert 10 using the wizard 130.

According to some embodiments of the invention, the system 100 may further enable experts 10 to determine suitability calculations for determining and presenting suitability of the expert's 10 health related care plan to patients 20 according to the patients' 20 possible health related goals (such as losing weight, reducing blood pressure, gaining weight, etc.) and according to the patient's 20 health related data. Therefore, the system 100 may further comprise a suitability assignment templates database 250; a care plans database 260; and a generic assignment models database 240.

The generic suitability assignment models database 240 may be operatively associated with the wizard 130 enabling the expert 10 to create a template of suitability assignments of the expert's 10 care plan(s) to patients' goals, using the wizard 130 by uploading a generic assignment model from the generic assignment models database 240 and using a generic assignment model associated with the expert's expertise to do so.

The suitability assignment templates database 250 may comprise templates of suitability assignments created by multiple experts 10 of one or more fields of expertise.

The wizard 130 may enable the expert 10 to customize rules in the generic model to determine the suitability between the expert's care plan and each possible patient's health related goals; creating a suitability template of the care plan, which includes all the customized rules.

Accordingly, the main server 120 may enable receiving a health related goal and health data of a patient 20; calculating the suitability of known care plans (of one or more experts 10) in relation to the received goal, according to each plan's suitability template, where the suitability is calculated according to the customized rules in the template of each care plan in relation to the received goal; and retrieving and presenting care plans that are most suitable with the received health related goal.

The system 100 may present a predefined number of the resulting most suitable care plans to the user (e.g. expert or patient) in a descending order of suitability.

The wizard 130 may enable the expert 10 to customize a generic model, which is a generic software tool that enables processing, transmitting, retrieving and presenting health related data. The customized generic model may be stored as a template of commands (that is the customized model), which may allow analyzing health related data of patients 20 (e.g. retrieved from the health database 220) according to the expert's 10 customization, and presenting the analysis results according to the customized presentation features also set by the expert 10 using the wizard 130.

According to some embodiments of the invention, as illustrated in FIG. 1, the wizard 130 may be operatively associated with at least one generic models database 230 enabling to store and retrieve generic models. For example, each generic model may be suited for a different medical or health field of expertise.

According to some embodiments of the invention, the Experts' templates database 210 may include templates of commands created by one or more experts 10 including the experts' 10 personal details associated therewith, to allow each expert 10 to use and/or customize his own personal template(s) and retrieve a selected template from the templates database 210.

Additionally, the health database 220 may include patient's 20 health related data such as the patients' 20 personal details, (e.g. a generic model for dietitians, for trainers, for cardiologists, etc.) to provide an expert 10 of a specific field with a generic model that already is adapted to the specific field e.g. comprising the suitable measure units, parameter types and profile types for the expert 10 to select from when customizing the generic model into a personally customized template of commands.

According to some embodiments of the invention, the resulting health related profile of a patient 20, resulting from the analysis carried out according to one expert's 10 template of commands may be used to deduce the health related goal or goals selected for searching suitable health care plans. The deduction may be carried out by the expert 10 and or any other user and/or by a predefined deduction algorithm in the system 100.

The wizard 130 may be a software application that may be operated by the expert's station 120, the main server 120 or partially at each of them. Accordingly, the wizard 130 may be installed at the main server 120 and/or at the expert's station 110.

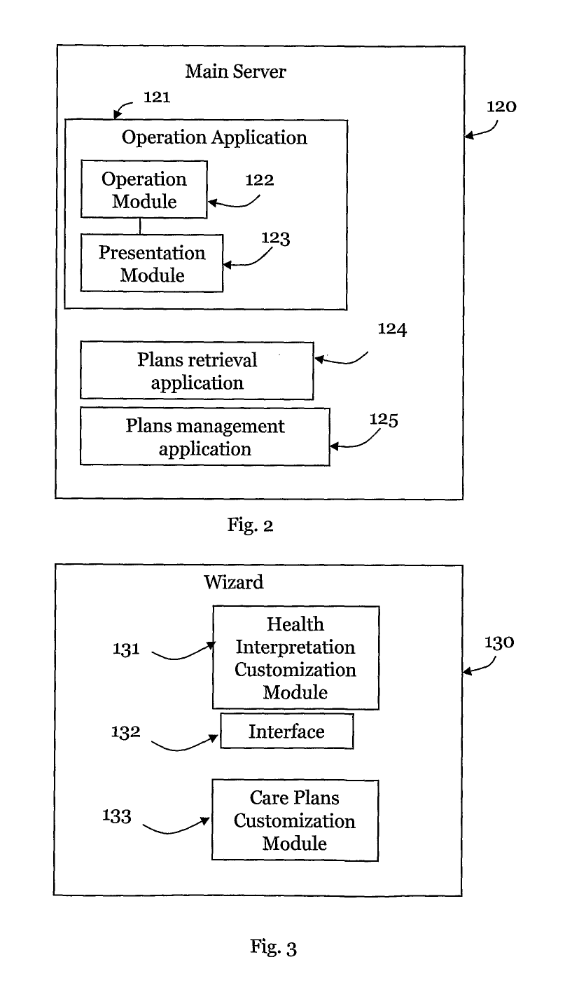

FIG. 2 is a block diagram, schematically illustrating the main server 120 of the system 100, according to some embodiments of the invention. The main server 120 may comprise:

an operation application 121 for operating the customized templates of commands for calculating and presenting of patient's 20 health related profile;

a care plans retrieval application 124, enabling to retrieve care plans that are most suitable to a patient's input goal; and

plans management application 125 for allowing the patient 20 to report progress of following the care plan chosen by the patient 20 according to the suitability presentation and for monitoring the patient's 20 implementation of the selected plan.

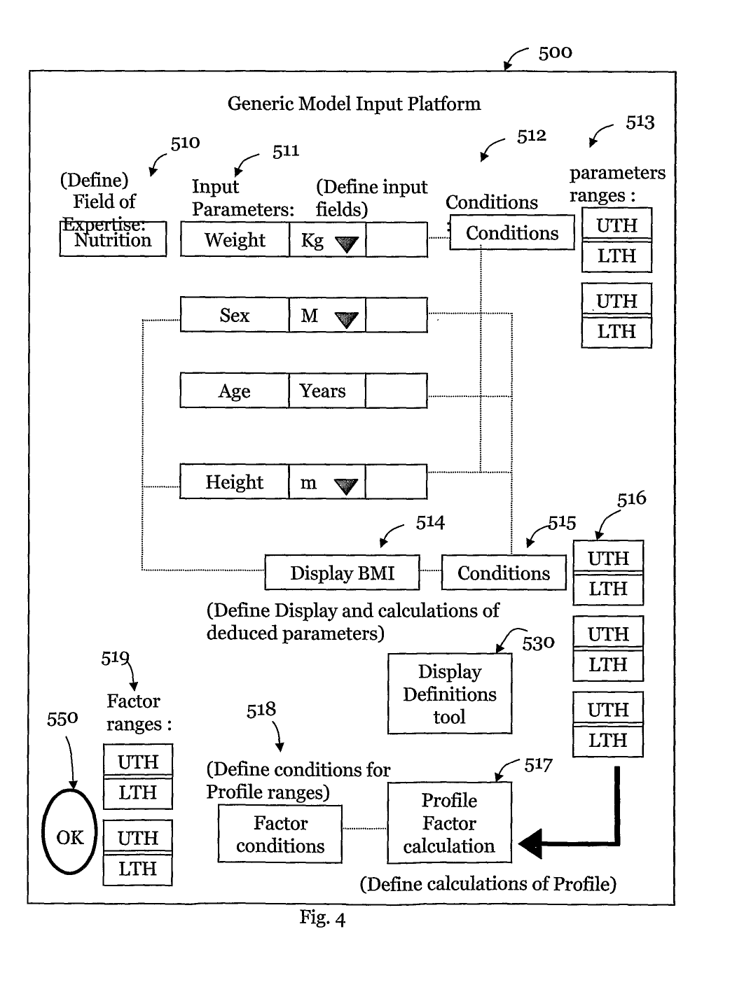

The operation application 121 may comprise an operation module 122 for carrying out the retrieval, transmission and processing of the data and a presentation module 123 for carrying out the presenting of profile sheets (e.g. see FIG. 4) for presenting the patient/expert of the patient's resulting health related profile, and health condition (e.g. to show the patient/expert whether the profile factors and/or parameters exceed normal ranges etc.

According to some embodiments of the invention, the operation and presentation modules 122 and 123 may be able to allow the expert 10 to:

(i) retrieve his or others' template from the experts' templates database 210 by identifying himself or the desired template;
(ii) retrieving input parameters of a specific patient 20 by following the commands in the template to retrieve the appropriate data from the health database 220, by inserting some predefined personal details of the patient 20 to allow identifying the patient 20 (e.g. the patient's ID number);
(iii) manipulating (analyzing) the parameters according to commands of the template e.g. to produce profile factors values and profile stratus, the deduced parameters values and to analyze these values positioning in correspondence to the correct ranges according to the predefined conditions; and
(iv) presenting the values of the profiles/parameters showing their positioning in correspondence to the ranges of values relating to each particular presented profile/parameter, according to predefined prioritized presentation setup, customized by the expert 10.

FIG. 3 is a block diagram, schematically illustrating the wizard 130, according to some embodiments of the invention. The wizard 130 may comprise:

a health interpretation customization module 131, for enabling the expert 10 to customize a health related generic model;

an interface 132 for allowing the expert 132 to input and view data for customizing the generic model and for associating suitability to care plans; and

a care plans customization module 133 for associating suitability to care plans.

The interface 132 may include various interface platforms (e.g. selected through a menu) for allowing the expert 10 to either customize a generic model for creating a template of commands or for assigning suitability factors to care plan(s).

FIG. 4 is a block diagram, schematically illustrating an input platform 500 of the wizard 130 for allowing the expert 10 to customize and create templates of commands for analyzing and presenting health related data, according to some embodiments of the invention.

According to these embodiments, the input platform 500 may include:

at least one field of expertise input field 510, enabling the expert 10 to define the general and/or sub field of his/her expertise (e.g. dietitian and dietitian for vegetarians);

at least one parameter definition input field 511, enabling the expert 10 to define parameter types (such as height, weight, etc.) that are important for his method of calculating each patient's 20 profile (e.g. by selecting parameters types out of a predefined list related to the selected or defined field of expertise);

parameters' conditions input fields 512 and parameters' ranges definition fields 513, enabling the expert 10 to define conditions according to which a value of an input parameter will be considered within/above/below a defined range of corresponding values, and to set upper and lower thresholds for each condition—defining each such range;

at least one deduced parameter input field 514, enabling the expert 10 to define a parameter that can be deduced from at least one other input parameter;

at least one deduced parameters' condition input filed 515 and deduced parameters' ranges definition fields 516, enabling the expert 10 to define conditions according to which a value of a deduced parameter will be considered within/above/below a defined range of corresponding values, and to set upper and lower thresholds for each condition—defining each such range;

at least one profile calculation field 517 enabling the expert 10 to define the way in which each profile is to be calculated (e.g. by defining a mathematical formula for calculating a profile value, where at least some of the parameters (either input and/or deduced) are the parameters of the formula); and

at least one profiles condition input filed 518 and profiles' ranges definition fields 519, enabling the expert 10 to define conditions according to which a value of a profile will be considered within/above/below a defined profiles' range of corresponding values, and to set upper and lower thresholds for each condition—defining each such range.

Additionally, the expert 10 may be able to define the measure units for each input and/or deduced parameter (e.g. by selecting the units out of a predefined list associated with each parameter type).

For example, a nutrition expert 10 may define his field of expertise 510 and then automatically view selection options for input and deduced parameters related to this expertise such as, weight, gender, height, calories intake, BMI and the like; as well as the related optional units associated with each parameter (e.g. weight can be in pounds, Kg and the like) enabling the expert 10 to select his/her favorable units. The deduced parameters may automatically be in units that correspond to the units selected for the input parameters ion which they depend.

For each input and/or deduced parameter and/or profile value, the expert 10 may be required to use the generic model to define threshold values for each parameters defining the “normality range” of values and the conditions for the defined ranges. For example, the expert 10 may define that a weight range between 50-80 Kg is considered “normal range” only under the conditions: female, between the age of 16-99 years, of height that is between 1.49-1.70 meters; whereas for male of height range of 1.78-1.99 meter and from age 21 and on the weight range may be between 55-90 Kg. Patients 20 that fall within the conditions of a certain set of values range may be checked for their values position within that range, defining the health states of the patient 20 (e.g. over/under weight, high/low risk for heart related diseases, etc.), to see whether the patient's 20 value exceeds the parameter's range (either above an upper threshold value or below a lower threshold value). This may require defining interrelations between the fields and parameters values.

Additionally, as illustrated in FIG. 4, the input platform 500 may further comprise a display definition tool 530 enabling the expert 10 to define the graphical presentation of each profile and/or parameter according to which the presented patient's 20 profiles and parameters will be presented using the presentation module 122.

According to some embodiments of the invention, the display definition tool 530 may further allow the expert 10 to define which parameters and/or profiles will be presented in the output presentation and in what order and the graphical manner in which the patient's 20 states (each state relating to a parameter or a profile representing the positioning of the value of the parameter/profile within the defined range associated with the parameter/profile). For example, a certain profile may be presented first as a scale indicating the profile's value according to a presentation of the range of values of this profile showing the position of the patients 20 value in the scale in a graphical manner. Other profiles may appear in a prioritized manner below the main profile.

Each expert 10 of the same field of expertise may select different profiles as their main ones and assign different priorities. For example, one nutritionist may consider the statistical factor indicating the chances of the patient to get a heart related disease is more important that the profile indicating the statistical factor indicating the chances for having lung related diseases and therefore decide on presenting the first profile and then the second one followed by all the input and deduced parameters' values' representations.

Once all input and deduced parameter and profile fields 510-511, 514 and 518; once all their conditions and ranges 512, 513, 515, 516 and 519; and the profile calculation and presentation features are defined 517 and 530; all these definitions may be translated by the wizard 130 into commands, which may be stored as a template of commands that is associated with the expert's 10 identifying details in the experts' templates database 210. The translating of the definitions and the saving of the template may be carried out once the user approves all his/her selected and defined fields, ranges, conditions and so forth, e.g. by pressing a virtual OK button 550, as illustrated in FIG. 4.

The operating application. 121 may be operatively associated with the main server 120 and/or the experts stations 110, enabling to produce patients' profile sheets presenting the health profile of each patient 20, by retrieving the expert's 10 specific template of commands, retrieving health data of the patient 20 form the health database 220 according to the commands in the template, processing and analyzing the patient's 20 health data according to these commands, to produce deduced parameters values and/or profile factors, and presenting at least part of the produced parameters and factors, according to the commands of the template.

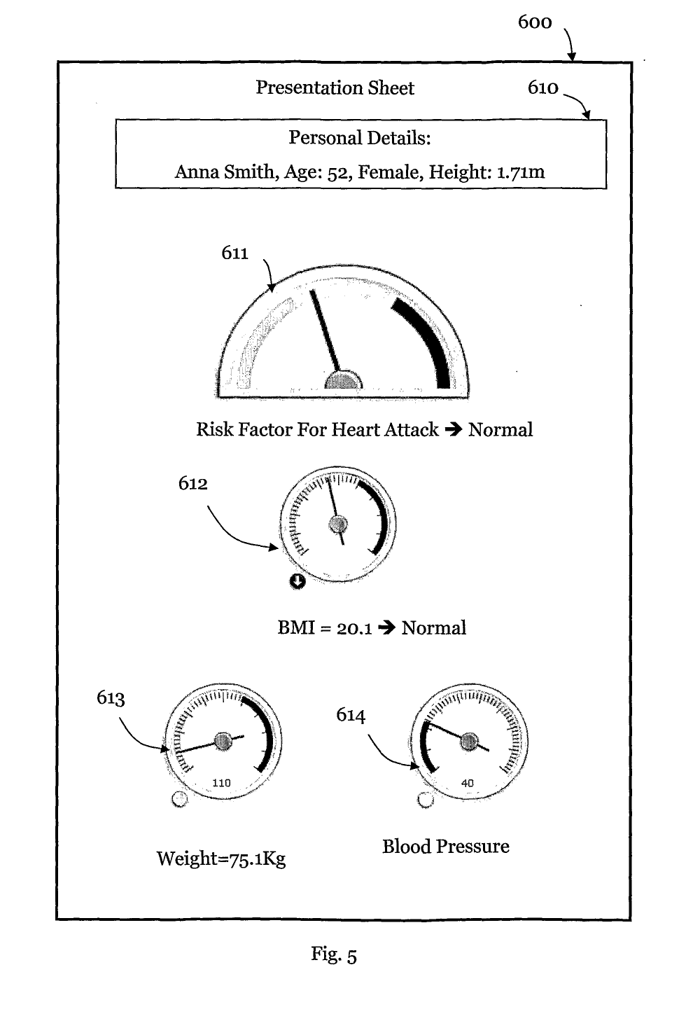

FIG. 5 schematically illustrates a profile sheet 600 of a patient, according to one expert's 10 template commands and definitions. According to this sheet 600. The personal details 610 of the patient may be automatically presented in the sheet. Additionally, A first main profile graphical indication 611 may present a scale icon showing the defined range of values, where the normal range is marked differently than the lower and/or upper range (e.g. by three different colors defining each range). The value of each of the patient's 20 profile factor may be marked by a line pointing to the value of the factor within the scale that is marked by the ranges. Each deduced parameter presentation 612 may be presented beneath the main profile factor(s) presentation 611 in a similar graphical manner as well as other input parameters 613 and 614, such as weight and blood pressure for example.

The profile factors may be any calculated value or estimation relating to the patient's 20 health associated with the expert's 10 field of expertise and his/her method of analyzing the patient's 20 health data.

The ranges may define what is considered a “normal value” of a parameter or an estimated health factor (e.g. the chances of getting a heart attack) of a patient 20 according to the expert's 10 analysis method, where upper and lower threshold values may define abnormal values exceeding the normal range (where the values are either above the upper threshold or below the lower threshold values).

The positioning of the patient's parameter, deduced parameter or profile within the defined range may represent the “state” of the patient according to the expert's 10 analysis method. For example, the patient 20 may be considered to have an overweight when the weight parameter of the patient 20 exceeds an upper threshold defined in the weight range by the expert 10.

According to some embodiments of the invention, the presentation of the estimated profile factor(s) of the patient 20 and the positioning of each represented factor or parameter in relation to a scale defining the ranges for “normal values” and “exceeding values”—may be graphical for the convenience of the expert 10.

The input parameters values may be retrieved from the health database 220, which may include all available health data of each patient 20 including each patient's personal details (e.g., name, age, gender, etc.), test results (e.g. blood pressure, pulse, etc.), measured details (e.g. weight, height etc.) and the like.

The profile may be one or more estimations of the patient's 20 health condition or state in relation to the expert's 10 field of expertise and school of method. For example, the profile may be a statistical factor that predicts the chances of the patient 20 to get heart diseases in relation to weight related data, according to a method of a dietitian expert 10 that follows (e.g. according to studies he/she follows) a certain method for calculating that statistical factor taking into consideration the patient's 20 age, gender, weight, height, calculated BMI, and country of birth.

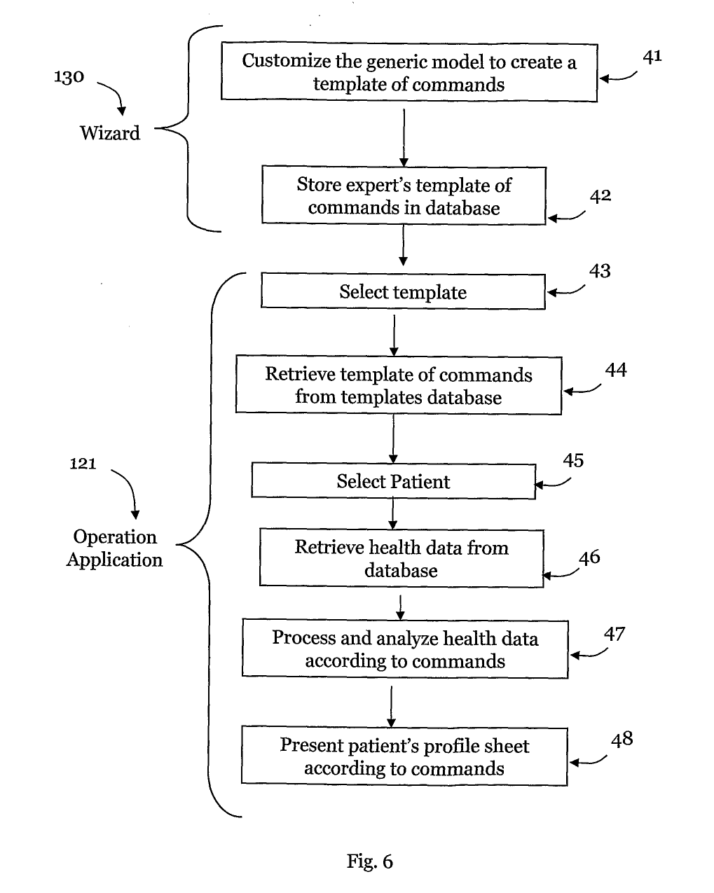

FIG. 6 is a flowchart, schematically illustrating a process of customizing templates and presenting of patients' 20 health related profile sheets 600 comprising various parameters and factors related to the patients' health according to the expert's field of expertise and analysis method.

According to these embodiments, the process may include:

customizing a generic model to create a template of commands 41, using the wizard 130, where the template of commands is a customization analysis tool for health related data;

storing the created template of commands 42 in at least one experts' templates database 210, where steps 41-42 may be carried by the expert 10 using the wizard 130;

selecting a template of commands 43, where the operation application 121 enables the expert 10 to select a desirable analysis tool to work with either out templates associated with the expert 10 or any other shared templates;

retrieving the selected template 44, which may be retrieved from the at least one templates database 210;

selecting a patient 45, where the expert 10 can select a patient 20 by giving some predefined identifier(s);

retrieving health related data 46 from the at least one health database 220 according to the patient's 20 identity and the application's 121 definitions and rules and according to the template commands defining which data to retrieve from all data stored associated with the patient 20;

processing and analyzing of the health data 47, according to the template's commands; and

presenting of a health profile sheet 48, according to presentation commands of the template.

According to some embodiments of the invention, steps 43-48 may be carried out by the operation application 121, which enables processing and analyzing of the patient's 20 health data and presenting of a health profile sheet 600, according to the template commands, where the template is a customized health analysis tool customized by either the same expert 10 to whom the sheet 600 is presented or any other expert 10 in a health related field.

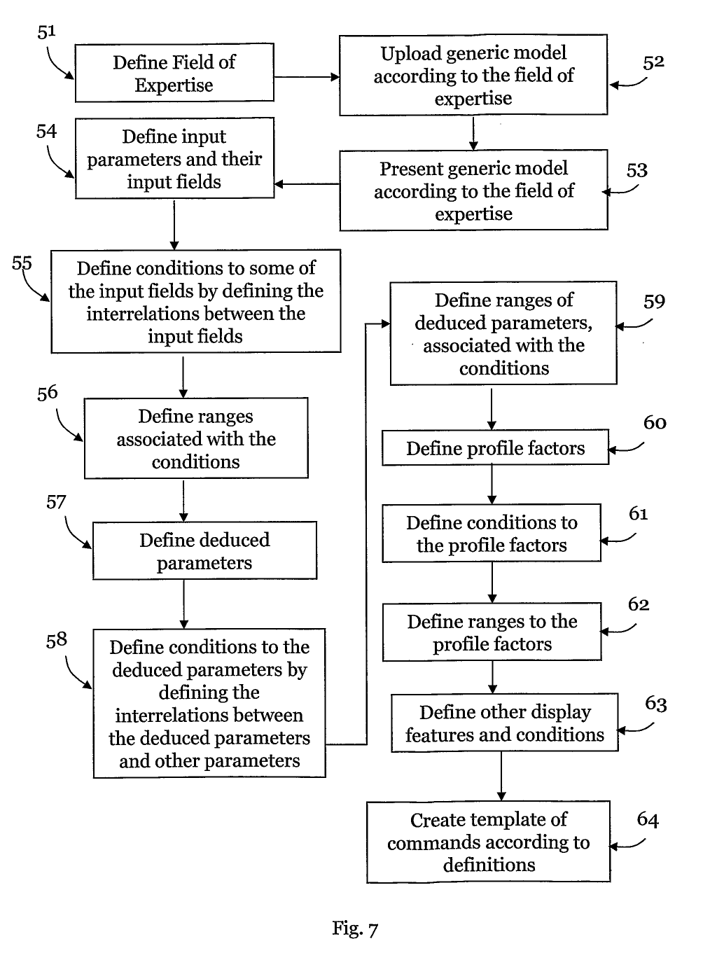

FIG. 7 is a flowchart, which schematically illustrates the process of customization 41 of the generic model in further details, according to some embodiments of the invention. To carry out the customization, the expert 10 may be required to use one or more input platforms 500 of the generic model, provided through the wizard 130.

According to these embodiments, the process may comprise at least some of the steps of:

defining a field of expertise 51, where the expert 10 selects or insert his/her field of expertise;

uploading 52 and presenting 53 a generic model input platform(s) 500, according to the defined field of expertise from the generic models database 230;

defining input fields of input parameters 54, where the platform 500 enables the expert 10 to define the parameters the expert 10 wishes to retrieve from the health database 220 to process and view by defining these parameter types as input fields, where the wizard 130 enables the expert 10 to select parameters and definitions out of predefined existing input fields and parameters, which are associated with the field of expertise;

defining conditions to at least some of the input parameters 55, where the conditions may be created by defining interrelations between some of the input fields;

defining the value ranges for each input parameter 56 by defining an upper and a lower threshold values defining the normal range therebetween and the exceeding ranges of parameter values, wherein each range associated with each input parameter may also be defined by the conditions;

defining deduced parameters 57, where the platform 500 enables the expert 10 to define the deduction mathematical and logical deduction;

defining conditions to at least some of the deduction parameters 58, where the conditions may be created by defining interrelations between some of the input parameters;

defining the value ranges for each deduced parameter 59 by defining an upper and a lower threshold values defining the normal range therebetween and the exceeding ranges of deduced parameter values, wherein each range associated with each input parameter may also be defined by the conditions;

defining profile factors 60, where the platform 500 enables the expert 10 to define the mathematical and logical calculating formula/algorithm for each factor (e.g. by using other deduced and/or input parameters and statistical algorithms);

defining conditions to at least some of the factors 61 where the conditions may be created by defining interrelations between some of the input parameters and deduced parameters;

defining the value ranges for each factor 62 by defining an upper and a lower threshold values defining the normal range therebetween and the exceeding ranges of factor's values, wherein each range associated with each factor may also be defined by the conditions;

defining other display features 63, such as the graphical presentation of each factor, deduced parameter and/or input parameter; and

creating a template of commands 64 according to all above mentioned definitions and conditions.

The template of commands, may then be saved in the template database 210 along with the expert's 10 details (e.g. name, field of expertise etc.) to allow associating the template with the expert 10 who created it.

The template may be used later on as an analysis software tool comprising or attaching to other command codes that enable the expert 10 to view patient's 20 analyzed data according to the expert's 10 definitions and analysis method. The analysis tool may comprise an interface enabling the expert 10 to input his/her personal identification and the patient's identifying input to enable the analysis tool to then use the identification data of the expert 10 to retrieve the correct template of commands and the patient's 20 identifying data to retrieve the patient's 20 health data from the health database 220 and to allow then to analyze the patient's 20 data by following the commands in the template using the health data of the patient 20 that was retrieved.

According to some embodiments of the invention, experts 10 may use other expert's 10 templates of commands by using the analysis tool and identifying the expert 10 of which template they wish to use.

Additionally or alternatively, the analysis tool may comprise security applications to only allow authorized users (e.g. experts 10) to retrieve templates they are authorized to use.

According to some embodiments of the invention, both the process of analyzing the health data according to the template of command and the creating of the template may be carried out in the main server 120, where the process of inputting the identifying data of the expert 10 and patient 20 may be carried out in the expert's station 110. Using the network(s) 99 to transmit and receive data, as known in the art.

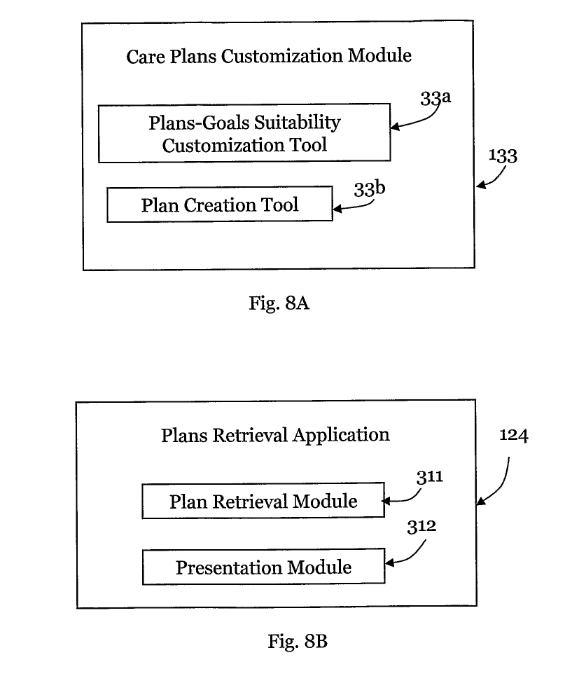

FIG. 8A is a block diagram, schematically illustrating the care plans customization module 133 for assigning suitability factors to experts health related plans, according to some embodiments of the invention.

The care plans customization module 133 may comprise a plans-goals suitability customization tool 33a and a plan creation tool 33b.

According to embodiments, the plans-goals suitability customization tool 33a may enable the expert 10 to retrieve at least one generic assignment model (e.g. from the generic assignment models database 240) that may allow him to define the manner in which the suitability of his or another expert's 10 care plan will be calculated in relation to one or more possible received health related goals and optionally also in relation to at least some of the patient's health related data (e.g. weight, age, gender etc.). The defining of the manner in which the suitability is calculated may be carried out by customizing predefined generic definitions and rules of the generic assignment model.

The resulting customized assignment model may be a suitability assignment template that may be stored as a suitability assignment template in the suitability assignment templates database 250, which may include rules for determining a suitability factor(s), which indicate(s) the level of suitability between the plan and each of the possible goals and the patient's properties. The rules of the template may be computer readable commands enabling the plans retrieval application 310 to calculate the suitability factor upon receiving the goals and the patient's properties by, for instance inputting the goal, the health parameters and personal properties of the patient 20 into a function, which is the embodiment of the computer readable commands (rules), and calculating the resulting suitability factor by applying the function upon the parameters and goal.

FIG. 8B is a block diagram, schematically illustrating the plans retrieval application 124 for enabling the patient 20 or the expert 10 to retrieve health related care plans according to the plans suitability to the patient's 20 health related goal, according to some embodiments of the invention.

The plans retrieval application 124 may comprise: a plans retrieval module 311; a presentation module 312.

According to embodiments, the plans retrieval module 311 may enable retrieving suitability assignment templates of various care plans and receiving/retrieving at least one of the health related goals and properties of a patient 20 and calculating the suitability level of each plan by operating the commands of the template's rules upon the inputted and/or retrieved patient's goal and properties. The plans retrieval module 311 may further include an interface enabling the patient 20 to select a favorite care plan.

According to embodiments, the presentation module 312 may enable sorting the resulting retrieved care plans according to predefined sorting rules and priorities (E.g. according to a decreasing effectiveness rate), enabling to present the most suitable plans according to the plans' suitability level in relation to the received patient's goal.

According to embodiments, the monitoring module 313 enables automatically monitoring the patient's progress in performing the selected favorite plan and notifying the patient 20 when the plan is not followed properly. For example, a monitoring table may be provided allowing the patient 20 to insert information according to predefined fields on periodic or scheduled basis (e.g. each day of a predefined time-period). For example, the patient may be required to specify his daily quantities and types of food consumed by the patient 20 to verify whether or not the patient is following a diet plan. The monitoring module 313 may enable processing the inserted data to monitor the patient's progress. Once the monitoring module 313 identifies inconsistencies with the plan in relation to the goal, the monitoring module 313 may enable notifying the patient 20 regarding those inconsistencies, via any predefined notification methods and techniques (e.g. via mail, SMS messages etc. using predefined text messages, or by highlighting exceeding quantities inserted by the patient 20 etc.). The monitoring module 313 may further enable the patient 20 to define alert parameters and destinations (e.g. to what device and in what manner will the alert be transmitted and presented).

According to embodiments, the feedback module 314 may enable patients 20 to feedback on the plans either by allowing them to insert free text comments and/or through predefined feedback fields that may allow the experts 10 to improve their knowledge regarding the success of theirs and others plans in order to enable updating their templates according to acquired knowledge.

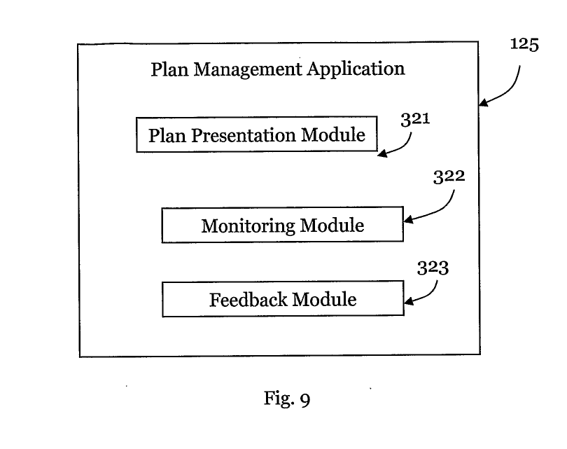

FIG. 9 schematically illustrates the plans management application 125 for managing presentation of care plans to patients that is operated by the main server 120, according to some embodiments of the invention.

The plans management application 125 may comprise:

a plan presentation module 321, enabling to present a selected care plan to the patient 20;

a monitoring module 322 which enables executing the monitoring and alerts commands of a retrieved selected care plan and thereby allow the patient 20 to input parameters and information relating to the patient's 20 implementation of the care plan, according to the plan's structure and presentation features, and to be presented with alerts relating to exceeding values or input information; the monitoring module 322 may additionally monitor the patient's 20 implementation of the care plan according to the monitoring rules set by the expert 10; and

a feedback module 323 enabling the patient 20 to insert feedback content (e.g. text, voice, and the like) to the plan, where the content of the feedback may be automatically stored and transmitted to the expert 10 and/or automatically stored along with the patient's 20 information (e.g. the goal, the patient's 20 properties etc.) for further analysis and/or rating of care plans.

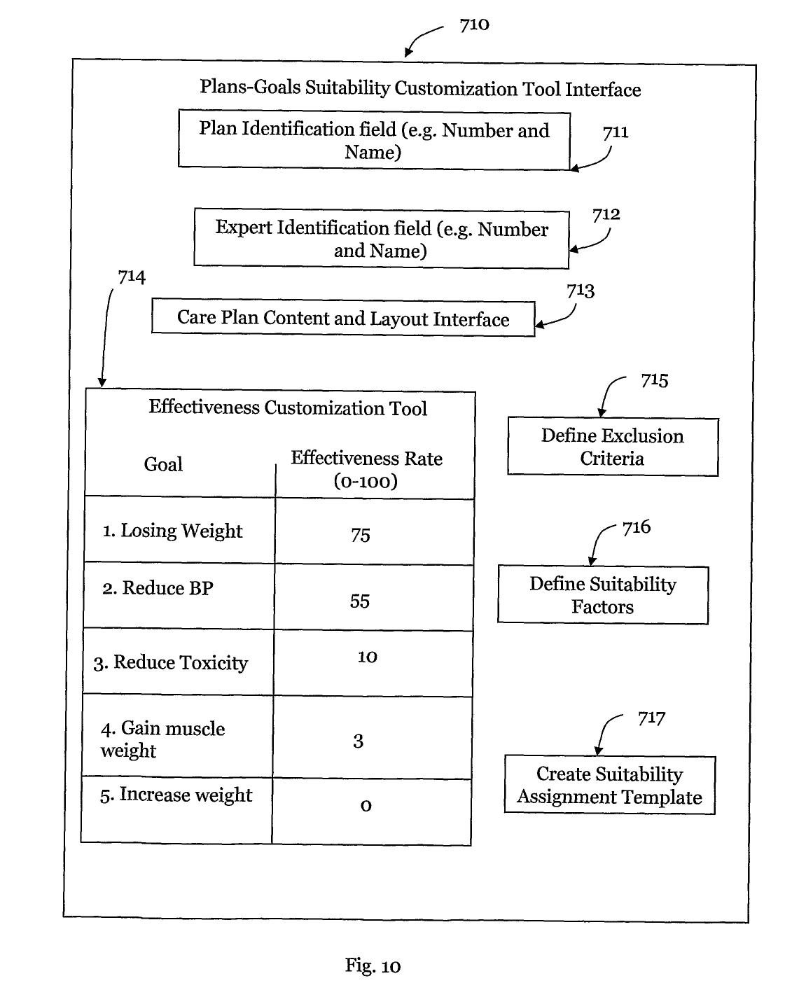

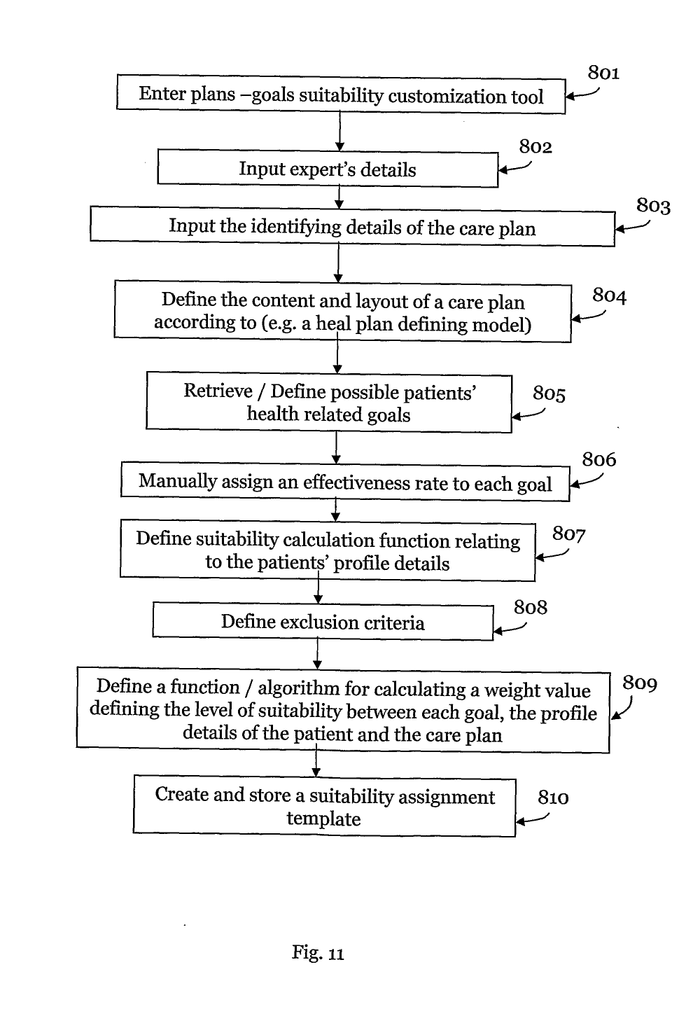

FIG. 10 is a block diagram, schematically illustrating an interface 710 of the plans-goals suitability customization tool 33a, enabling the expert 10 to define health related care plans and customize the rules and definitions associating the defined plans with possible patients' health related goals, according to some embodiments of the invention.

According to these embodiments, the interface 710 may comprise a plan identification input field 711, an expert identification input field 712, a care plan content and layout interface 713, an effectiveness customization tool 714, an exclusion criteria definition tool 715, a suitability definition tool 716 and a suitability assignment template creation tool 717.

According to embodiments, the plan identification input field 711 may enable the expert 10 to name a new or an updated plan.

According to embodiments, the expert identification input field 712 may enable the expert 10 to input his/her identification properties (e.g. name, docket number, field of expertise etc.).

According to embodiments, the care plan content and layout interface 713 may allow the expert 10 to either retrieve or select an existing care plan or create and define the content and layout of a new plan. For example, the care plan content and layout interface 713 may include predefined input fields such as: a free text content filed enabling the expert 10 to textually describe his care plan and its benefits; a timeline table enabling the expert to define the actions the patient 20 is required to perform or participate and the frequency and schedule of these actions (e.g. a timeline specifying the time in each day when the patient 20 is required to perform a physical exercise and the specification of each exercise at the indicated timing).

According to embodiments, the effectiveness customization tool 714 may be an interface table enabling the expert 10 to define/select/download a list of possible patients' health related goals and manually assign an effectiveness rate to each goal on the list.

The effectiveness rate may indicate how effective the plan is in relation to each health related goal on the list.

According to embodiments, the exclusion criteria definition tool 715 may enable the expert to define one or more conditions under which the plan is defined as “un-recommended” for the patient 20. These conditions may enable excluding the plan from being presented to the patient 20. The conditions may relate to possible values or properties of patients 20 taken from the patients' properties. For example, the expert 10 may define that his/her plan in un-recommended for patients 20 under the age of twenty or for patients 20 who suffer from low BP under a threshold BP value.

To allow the expert 10 to define those conditions, the exclusion criteria definition tool 715 may include all predefined fields that correspond to predefined properties of patients 20 in the system 100. For example, the system 100 may be preset to receive patients' 20 properties that include the patients' date of birth, sex, height (in meters), BP value and weight (in Kg). Correspondently, the exclusion criteria definition tool 715 may allow the expert 10 to define threshold values of at least one of the properties and optionally, define exclusion criteria of the plan in relation to the patient 20 by defining combination of exceeding values of the patient's 20 properties. For example, the expert 10 may define that the plan is only defined as “excluded” for patients 20 that are under the age of twenty and also weighs under 60 Kg.

According to embodiments, the suitability definition tool 716 may allow the expert 10 to define a function for calculating a level of suitability of the plan to the patient 20, according to the patient's properties. For example, the suitability definition tool 716 may enable the expert 10 to define a mathematical function for calculating the suitability value of a patient when inserting values of predefined properties of the patient 20. For example, a function that calculated the suitability value in relation to the patient's 20 weight, age and height.

According to embodiments, the suitability assignment template creation tool 717 may allow the expert to store all the definitions and functions and create a template that converts all defined and inserted properties into rules which may be computer readable commands enabling to receive the patient's 20 goal and properties as an input, process the input data according to a predefined processing method and output at least one of, for example, exclusion criteria result (yes/no); effectiveness value; and/or suitability value of each of the processed plans in the template.

According to embodiments, the system 100 may further allow receiving a multiplicity of health related goals, associated with the same patient, and assign a weight factor for each goal associated with each of the searched care plans (e.g. according to the effectiveness rate of each plan in relation to each goal), and determine the most suitable care plan according a predefined calculation function/algorithm (e.g. statistical calculation function).

FIG. 11 is a flowchart, schematically illustrating a method for customizing a generic model for determining the suitability of a care plan to at least one patient's health related goal, according to some embodiments of the invention. The method may comprise at least some of:

entering the plans-goals suitability customization tool interface 801;

inputting the identification properties of the expert 802;

inputting the identifying properties of the care plan 803;

defining the content and layout of the care plan 804 (e.g. using the plan creation tool and interface or retrieving a former tool and customizing it);

retrieving/defining possible health related goals 805;

manually assigning an effectiveness rate to each goal 806;

defining suitability calculation function, where the function enables calculating a suitability factor of the care plan to each goal according to at least some of the health related data of the patient 807;

defining exclusion criteria 808;

defining/selecting a function/algorithm for calculating a weight value for each possible goal 809, which may indicate the total level of suitability of the plan in relation to each goal and the patient's properties; and

Creating a suitability assignment template 810 including rules for calculating and outputting, for example, the effectiveness rate, an exclusion criteria result (Y/N), a suitability factor and the suitability weight value for each inputted or received goal of the plan.

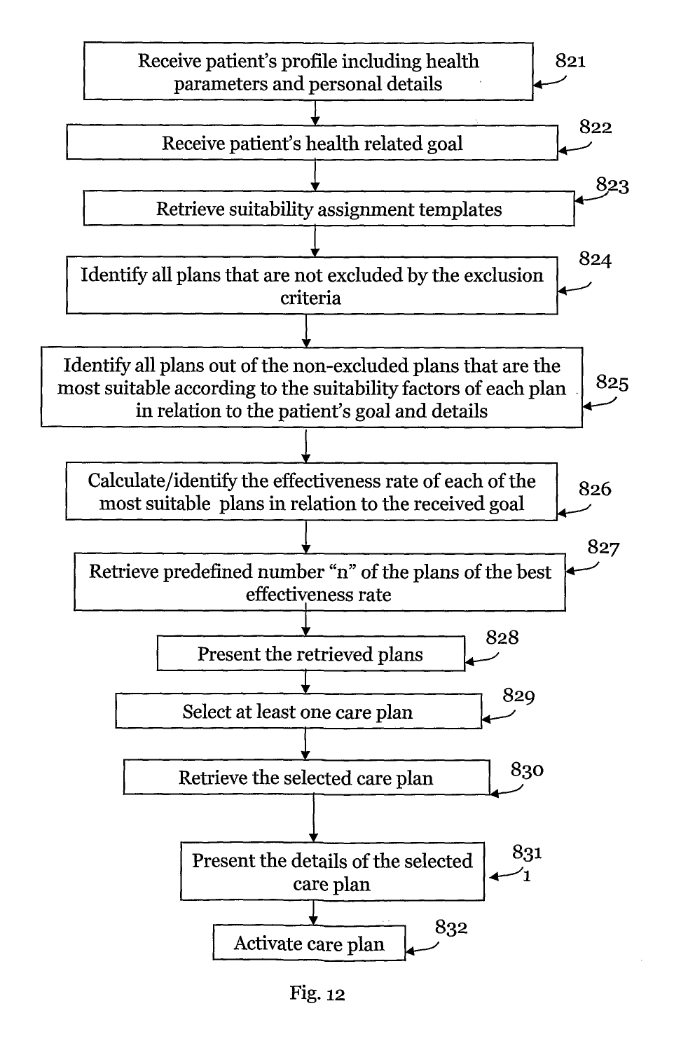

FIG. 12 is a flowchart, schematically illustrating the process of retrieving and presenting suitable care plans to a patient according to the patient's related health data and goal, according to some embodiments of the invention. The process may comprise:

receiving patient's profile including health parameters and personal properties 821;

receiving at least one patient's health related goal 822;

retrieve suitability assignment templates 823 (e.g. from the at least one suitability assignment templates database 250);

identifying care plans that are not excluded by the exclusion criteria of each of the plans 824 (e.g. by going through all plans in the at least one templates database 230);

identifying the most suitable plans out of the non-excluded plans according to each non-excluded plan's suitability factor 825 (e.g. using the patient's received personal and/or health properties);

calculating/identifying the effectiveness rate of each plan. of the most suitable plans in relation to the patient's received health related goal 826;

retrieving a predefined number “N” of the most suitable health related plans (e.g. the suitable plans with the highest effectiveness rate) 827;

present the titles and description of the most suitable plans 828;

selecting at least one of the displayed plans (where the user can carry out the selection) 829;

retrieving the selected care plan 830 (e.g. from the care plans database 210); and

presenting the details of the selected care plan 831.

Additionally, the selected care plan may be activated 832 enabling to the user (e.g. the patient 20) to follow the plan and monitor the patient's following and implementation of the plan.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A system for enabling to analyze health related data associated with at least one patient, said system comprising:
at least one expert's station, which is a computerized station of a health related expert;
at least one health database comprising health related data of patients;
a wizard software application operatively associated with said at least one expert's station, enabling the expert to create at least one template of commands for analyzing the health related data of the patient according to the expert's analysis school of method, using at least one generic model associated with the field of expertise of the expert, wherein said analysis calculates health related profile parameters of patients;
at least one templates database, enabling to store templates of commands created by the expert;
at least one generic models database, enabling the wizard to retrieve and store a generic model associated with the expert's field of expertise; and
at least one main server, operatively associated with said wizard, said expert's station, said health database and said templates database, enabling to retrieve data from and store data in the databases and use the template of commands to analyze the health data of a patient, according to the analysis method of the expert,
wherein the analysis is carried out by operating of the commands in the template, wherein at least one of said commands in the template enables calculating of patients' health related profile.

2. The system of claim 1 further enables presenting of the analyzed data to said expert.

3. The system of claim 1, wherein said main server comprises an operation application for operating the customized templates of commands for calculating and presenting of patient's health related parameters and profile.

4. The system of claim 3, wherein said operation application comprises:
an operation module for retrieving health related data of the patient from the health database, retrieving the expert's template of commands and processing the patient's health related data according to the template of commands; and
a presentation module for presenting the patient's resulting health related parameters and profile.

5. The system of claim 4, wherein the resulting health related parameters and profile of the patient are presented through a presentation sheet enabling to graphically present the results.

6. The system of claim 1, wherein said wizard comprises:
a health interpretation customization module, for enabling the expert to customize a health related generic model to create the template of commands; and
an interface for allowing the expert to input and view data for customizing the generic model there-through,
wherein said interface provides an input platform for presenting the generic model and for allowing the expert to define input parameters, deduced parameters, and parameters' normal ranges of values for each of the input and deduced parameters, according to which the resulting profile status of patients are calculated and presented.

7. The system of claim 1 further comprising a generic assignment models database operatively associated with said wizard and a care plans database comprising experts care plans, wherein said wizard further enables the expert to assign suitability to health related care plans according to possible health related goals of patients, by providing the generic assignment model for customization thereof to create an assignment template for assigning said suitability of the patient's care plan to each possible goal.

8. The system of claim 7, further comprising a suitability assignment templates database operatively associated with said main server, for allowing said wizard to store created assignment templates therein and said server to retrieve templates there from to allow receiving a patient's health related goal, calculate most suitable care plans in relation to said received goal, according to a set of rules in the assignment template and present most suitable care plans.

9. The system of claim 8, wherein said main server further comprises:
a plans retrieval application enabling to calculate and retrieve care plans from said care plans database that are most suitable to a patient's input goal, according to the assignment template of an expert; and
plans management application for allowing the patient to report progress of following the care plan chosen by the patient according to the suitability presentation and for monitoring the patient's implementation of the selected plan.

10. The system of claim 9, wherein said wizard further comprises a suitability assignment customization tool for associating suitability to care plans according to patients possible health related goals.

11. The system of claim 10, wherein said plans management application comprises:
a plan presentation module for presenting a selected care plan to the patient, wherein said plan is selected out of presented most suitable care plans;
a monitoring module for executing the monitoring and alerts commands of a retrieved selected care plan and thereby allow the patient to input parameters and information relating to the patient's implementation of the care plan, according to the plan's structure and presentation features, and to monitor the patient's implementation of the care plan according to the monitoring rules set by the expert; and
a feedback module for enabling the patient to insert feedback content to the care plan, wherein the content of the feedback is automatically transmitted for further analysis.

12. The system of claim 7, further enabling deducing the health related goal of a patient according to health profile of the patient resulting from the analysis carried out by operating the expert's template of commands upon the patient's health related data.

13. A computer implemented method of enabling to analyze health related data associated with at least one patient, said method comprising:
retrieving a generic model that is associated with the expert's field of expertise; and
enabling the expert to create a template of commands, using the retrieved generic model, wherein said template allows analyzing health data of the patient according to the expert's analysis school of method;
receiving health related data of a patient; and
analyzing the received health related data according to the expert's template of commands by operating the commands of said template using health related data of said patient,
wherein said commands enable calculating health related profile of the patient.

14. The method of claim 13 further comprising storing said template of commands created by the expert.

15. The method of claim 13 further comprising presenting of the analyzed data of each patient to said expert.

16. The method of claim 13 further comprising:
defining input fields of input parameters, wherein an interface platform of the retrieved generic model enables the expert to define the parameters f the health related data that the expert wishes to retrieve process and view by defining parameter types as input fields;
defining conditions to at least some of the input parameters, wherein the conditions are created by defining interrelations between at least some of the defined input fields; and
defining value ranges for each input parameter.

17. The method of claim 16 further comprising:
defining deduced parameters, wherein an interface platform of the retrieved generic model enables the expert to define a mathematical calculation for calculating the deduced parameters from at least one of the input parameters;
defining conditions to at least some of the deduction parameters, wherein the conditions are created by defining interrelations between at least some of the input parameters; and
defining value ranges for each deduced parameter.

18. The method of claim 17 further comprising:
defining profile factors, wherein an interface platform of the retrieved generic model enables the expert to define a calculation for calculating each factor;
defining conditions to at least some of the factors, wherein the conditions are created by defining interrelations between at least some. of the input parameters and the deduced parameters; and
defining value ranges for each factor.

19. The method of claim 18 further comprising defining display features, which include graphical presentation of at least one of the factors, deduced parameter, input parameter and their associated normal values ranges.

20. The method of claim 1 further comprising deducing at least one health related goal from the resulting analysis of a patient's health related data, according to the expert's template of commands.

21. A computer implemented method of providing at least one suitable health related care plan of an expert to patients' health related goals, said method comprising:
assigning suitability of the expert's care plan to possible patient's health related goals by customizing rules of at least one generic model enabling said assignment;
creating a suitability assignment template of the care plan, which includes all the customized rules of the generic model;
receiving at least one health related goal of a patient;
determining the suitability of known care plans in relation to said received goal, according to the suitability assignment template of each of the care plans, wherein the suitability is calculated according to the customized rules of the suitability assignment template in of each care plan in relation to the received goal; and
presenting care plans that are most suitable in relation to said received health related goal.

22. The method of claim 21, wherein said assignment of suitability comprises manually assigning an effectiveness rate to each possible goal.

23. The method of claim 22, wherein said assignment of suitability further comprises defining suitability calculation function, wherein said function enables calculating a suitability factor of the care plan to each goal according to at least some of the health related data of the patient.

24. The method of claim 23, wherein said assignment of suitability further comprises defining exclusion criteria for excluding the care plan in relation to the goal.

25. The method of claim 22, wherein said assignment of suitability further comprises defining an algorithm for calculating a weight value for each possible goal, for enabling to calculate a total level of suitability of the care plan in relation to each goal and the patient's health related data.

26. The method of claim 25, wherein said determining the suitability of known care plans includes:
identifying care plans that are not excluded by the exclusion criteria of each of the care plans;
calculating the suitability factor of each of the non-excluded care plans;
identifying the most suitable care plans out of the non-excluded plans according to each non-excluded plan's suitability factor; and
calculating the effectiveness rate of each plan of the most suitable plans in relation to the patient's received health related goal.

27. The method of claim 26, further comprising retrieving a predefined number of the most suitable health related plans.

28. The method of claim 27, wherein the predefined number of the most suitable care plans are presented according to a descending effectiveness order.

29. The method of claim 21, wherein said presenting of care plans that are most suitable in relation to said received health related goal is carried out by presenting titles and description of the most suitable plans.

30. The method of claim 21, further comprising:
selecting at least one of the displayed plans, wherein the patient carries out said selection;
retrieving the selected care plan details from a care plans database; and
presenting the details of said retrieved care plan to the patient.

31. The method of claim 30, further comprising activating the care plan to allow implementation and monitoring of the patient's implementation of said plan.

32. The method of claim 21 further comprising allowing patients to feedback on care plans.

33. The method of claim 21, further comprising storing the created suitability assignment template in a suitability assignment database.
